(19) United States
(12) Patent Application Publication
(10) Pub. No.: US 2026/0259620 A1
(43) Pub. Date: Sep. 3, 2026

(54) TOUCH-SENSITIVE SYSTEM AND METHOD

(71) Applicant: TouchNetix AS, Trondheim (NO)

(72) Inventor: Trond Jarle PEDERSEN, Trondheim (NO)

(73) Assignee: TouchNetix AS, Trondheim (NO)

(21) Appl. No.: 18/994,695

(22) PCT Filed: Aug. 17, 2023
(86) PCT No.: PCT/EP2023/072692

§ 371 Date: Jan. 15, 2025

(30) Foreign Application Priority Data
Aug. 24, 2022 (GB) 2212315.2

(51) Int. Cl. G06F 3/041; B60K 35/22; G06F 3/044

(52) U.S. Cl. CPC G06F 3/0416; B60K 35/22; G06F 3/0443; B60K 2360/1438

(57) ABSTRACT

Described is a touch-sensitive system for sensing one or more touches or objects at a sensing surface. The touch-sensitive system includes an electrode array comprising at least one electrode, the electrode array defining the sensing surface; receiver circuitry configured to couple to the electrode array and receive signals from the electrode array; a controller configured to receive signals from the receiver circuitry and determine a property of a touch or object sensed at the sensing surface; and first drive circuitry configured to generate a first drive signal to be applied to the electrode array. The first drive circuitry is remote from the electrode array and arranged to apply the first drive signal to a user of the touch-sensitive system such that when a user of the touch-sensitive system touches or approaches. The receiver circuitry is configured to receive a signal from the electrode array.

### BACKGROUND OF THE INVENTION

The present invention relates to the field of touch sensors, for example touch sensors for overlying a display screen to provide a touch-sensitive display (touch screen). In particular, embodiments of the invention relate to processing techniques for determining the presence of a genuine touch on a touch sensitive surface of a touch sensitive apparatus even in the presence of conductive objects not corresponding to a touch on the touch sensitive surface.

A capacitive touch sensor can be generalised as one that uses a physical sensor element comprising an arrangement of electrically conductive electrodes extending over a touch sensitive area (sensing area) to define sensor nodes and a measurement circuitry connected to the electrodes and operable to measure changes in the electrical capacitance of each of the electrodes or the mutual capacitance between combinations of the electrodes. The electrodes are typically provided on a substrate. In conventional systems, a driver applies a signal (such as a time-varying current) to the array of electrodes. A user (or an object) when approaching or contacting the electrode array, electrically interacts with the driven electrode array and as such it is possible to detect the presence or absence of a user's touch, and in some cases, a relative position of the user's touch.

While such conventional systems have certain advantages, one disadvantage with such techniques is the ability to distinguish between different user's or different objects interacting with the capacitive touch sensor. Indeed, in the above example where the electrode array is driven by a signal applied to the electrode array, when two users interact with the electrode array in substantially the same manner, the way in which the driven electrode array is affect is substantially the same regardless of the user. Hence, conventional systems are incapable of distinguishing between inputs received from different users.

There is therefore a desire to provide touch sensors or systems with the ability to distinguish between touches (inputs) received from different users.

### SUMMARY OF THE INVENTION

According to a first aspect of the invention there is provided a touch-sensitive system for sensing one or more touches or objects at a sensing surface, the touch-sensitive system including: an electrode array comprising at least one electrode, the electrode array defining the sensing surface; receiver circuitry configured to couple to the electrode array and receive signals from the electrode array; a controller configured to receive signals from the receiver circuitry and determine a property of a touch or object sensed at the sensing surface; and first drive circuitry configured to generate a first drive signal to be applied to the electrode array. The first drive circuitry is remote from the electrode array and arranged to apply the first drive signal to a user of the touch-sensitive system such that when a user of the touch-sensitive system touches or approaches, directly or via a held object, the sensing surface, the first drive signal is subsequently coupled to the electrode array, and wherein the receiver circuitry is configured to receive a signal from the electrode array corresponding to the first drive signal applied to the sensing surface via the user.

According to a second aspect of the invention there is provided a vehicle comprising the touch-sensitive system of the first aspect, wherein the first transmitter apparatus and/or second transmitter apparatus are each mounted to an electrically conductive component of a seat, wherein the electrically conductive component is arranged to contact a user when the user is sitting in the seat.

According to a third aspect of the invention there is provided a method of operating a touch-sensitive system for sensing one or more touches or objects at a sensing surface, the touch-sensitive system comprising an electrode array including at least one electrode, the electrode array defining the sensing surface; receiver circuitry configured to couple to the electrode array and receive signals from the electrode array; a controller configured to receive signals from the receiver circuitry and determine a property of a touch or object sensed at the sensing surface; and first drive circuitry configured to generate a first drive signal to be applied to the electrode array, wherein the first drive circuitry is remote from the electrode array. The method includes applying a first drive signal to a user of the touch-sensitive system, coupling the first drive signal to the electrode array when a user of the touch-sensitive system touches or approaches, directly or via a held object, the sensing surface, and receiving, at the receive circuitry, a signal from the electrode array corresponding to the first drive signal applied to the sensing surface via the user.

It will be appreciated that features and aspects of the invention described above in relation to the first and other aspects of the invention are equally applicable to, and may be combined with, embodiments of the invention according to other aspects of the invention as appropriate, and not just in the specific combinations described above.

### BRIEF DESCRIPTION OF THE DRAWINGS

The invention is now described by way of example only with reference to the following drawings in which:

FIG. 1 schematically illustrates a touch sensitive apparatus in accordance with certain embodiments of the invention;

FIG. 2 schematically illustrates a self-capacitance measurement mode of the touch sensitive apparatus, specifically with a view to explaining the principles of self capacitance measurement;

FIG. 3 schematically illustrates a mutual-capacitance measurement mode of the touch sensitive apparatus, specifically with a view to explaining the principles of mutual capacitance measurement;

FIG. 4 schematically illustrates a touch sensitive system in accordance with a first embodiment of the invention, and specifically showing a transmitter provided remote to the touch sensitive apparatus and arranged to apply a drive signal to a first user;

FIG. 5 schematically illustrates a touch sensitive system in accordance with a second embodiment of the invention, and specifically showing a pair of transmitters both provided remote to the touch sensitive apparatus and arranged to apply respective drive signals to a respective first user and second user;

FIG. 6 schematically illustrates an example system which employs the touch sensitive apparatus of FIG. 4 or 5 in accordance with certain embodiments of the invention;

FIG. 7 schematically illustrates a modification of the touch sensitive system of FIG. 5 in which a drive circuitry configured to apply a drive signal directly to the electrode array of the touch-sensitive apparatus is provided;

FIG. 8 schematically illustrates an example application in a vehicle of the touch sensitive systems of FIGS. 5 and 7; and

FIG. 9 is a flow diagram representing an example method for utilising the systems of FIGS. 4, 5, 6, 7 and 8 in accordance with embodiments of the present invention.

### DETAILED DESCRIPTION

The present disclosure relates broadly to a touch-sensitive system. The touch-sensitive system comprises a touch-sensitive apparatus and at least one transmitter. The at least one transmitter is provided remote from the touch-sensitive apparatus. The at least one transmitter is configured to apply a signal (a drive signal) to at least one user (where typically one transmitter is provided per user). When the user touches the touch-sensitive apparatus, the drive signal applied by the transmitter electrically couples to an array of electrodes forming a touch sensitive surface provided as part of the touch-sensitive apparatus. Circuitry (or a controller) is provided which is capable of obtaining measurements from the electrode array. In the presence of a touch which electrically couples to the electrode array, the obtained measurements vary from a steady state (i.e., measurements obtained in the absence of a touch). Accordingly, the circuitry is able to identify the presence of a touch in addition to the location of the touch (based on which measurements indicate the presence of a touch), based on the coupling of the drive signal generated by the transmitter and applied to the user. Additionally, when a plurality of transmitters is provided, each transmitter can be provided in association with a given user. When the drive signals between the plurality of transmitters are different, i.e., are of a different frequency, circuitry may be provided which is capable of distinguishing which transmitter (and thus which user) the drive signal originated from. In this way, multiple users may interact with the same touch-sensitive apparatus to provide respective different input signals, which may be used to control or perform different functions in apparatuses that use the touch-sensitive system as an input mechanism.

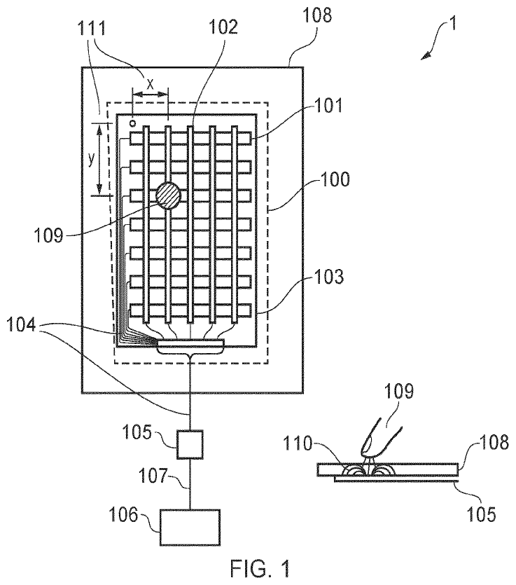

FIG. 1 schematically shows an example of a touch-sensitive apparatus 1. The touch-sensitive apparatus 1 is represented in plan view (to the left in the figure) and also in cross-sectional view (to the right in the figure).

The touch-sensitive apparatus 1 comprises a sensor element 100, measurement circuitry 105, processing circuitry 106, and cover 108. The sensor element 100 and cover 108 may, more generally be referred to as a touch screen or touch-sensitive element of the touch-sensitive apparatus 1, while the measurement circuitry 105 and processing circuitry 106 may, more generally, be referred to as the controller of the touch-sensitive apparatus 1.

The touch screen is primarily configured for establishing the position of a touch within a two-dimensional sensing area by providing Cartesian coordinates along an X-direction (horizontal in the figure) and a Y-direction (vertical in the figure). In this implementation, the sensor element 100 is constructed from a substrate 103 that could be glass or plastic or some other insulating material and upon which is arranged an array of electrodes consisting of multiple laterally extending parallel electrodes, X-electrodes 101 (row electrodes), and multiple vertically extending parallel electrodes, Y-electrodes 102 (column electrodes), which in combination allow the position of a touch 109 to be determined. To clarify the terminology, and as will be seen from FIG. 1, the X-electrodes 101 (row electrodes) are aligned parallel to the X-direction and the Y-electrodes 102 (column electrodes) are aligned parallel to the Y-direction. Thus the different X-electrodes allow the position of a touch to be determined at different positions along the Y-direction while the different Y-electrodes allow the position of a touch to be determined at different positions along the X-direction. That is to say in accordance with the terminology used herein, the electrodes are named (in terms of X- and Y-) after their direction of extent rather than the direction along which they resolve position. Furthermore, the electrodes may also be referred to as row electrodes and column electrodes. It will however be appreciated these terms are simply used as a convenient way of distinguishing the groups of electrodes extending in the different directions. In particular, the terms are not intended to indicate any specific electrode orientation. In general, the term “row” will be used to refer to electrodes extending in a horizontal direction for the orientations represented in the figures while the terms “column” will be used to refer to electrodes extending in a vertical direction in the orientations represented in the figures. The X-electrodes 101 and Y-electrodes 102 define a sensing (or sense) area, which is a region of the substrate 103 which is sensitive to touch.

In some cases, each electrode may have a more detailed structure than the simple “bar” structures represented in FIG. 1, but the operating principles are broadly the same. The sensor electrodes are made of an electrically conductive material such as copper or Indium Tin Oxide (ITO). The nature of the various materials used depends on the desired characteristics of the touch screen. For example, a touch screen may need to be transparent (for example if it overlays a display), in which case ITO electrodes and a plastic substrate are common. On the other hand, a touch pad, such as often provided as an alternative to a mouse in laptop computers is usually opaque, and hence can use lower cost copper electrodes and an epoxy-glass-fibre substrate (e.g. FR4). Referring back to FIG. 1, the electrodes 101, 102 are electrically connected via circuit conductors 104 to measurement circuitry 105, which is in turn connected to processing circuitry 106 by means of a circuit conductor 107. The measurement circuitry 105 and/or the processing circuitry 106 may each be provided by a (micro)controller, processor, ASIC or similar form of control chip. Although shown separately in FIG. 1, in some implementations, the measurement circuitry 105 and the processing circuitry 106 may be provided by the same (micro)controller, processor, ASIC or similar form of control chip. The measurement circuitry 105 and/or the processing circuitry 106 may be comprised of a printed circuit board (PCB), which may further include the various circuit conductors 104, 107. The measurement circuitry 105 and the processing circuitry 106 may be formed on the same PCB, or separate PCBs. Note also that the functionality provided by either of the measurement circuitry 105 and the processing circuitry 106 may be split across multiple circuit boards and/or across components which are not mounted to a PCB. The processing circuitry 106 interrogates the measurement circuitry 105 to recover the presence and coordinates of any touch or touches present on, or proximate to, the sensor element 100.

Generally speaking, the measurement circuitry 105 is configured to perform capacitance measurements associated with the electrodes 101, 102 (described in more detail below). The measurement circuitry 105 outputs the capacitance measurements to the processing circuitry 106, which is arranged to perform processing using the capacitance measurements. The processing circuitry 106 may be configured to perform a number of functions, but at the very least is configured to determine when a touch 109, caused by an object such a human finger or a stylus coming into contact with the sensing area of the sensor element 100 with appropriate analysis of relative changes in the electrodes' measured capacitance/capacitive coupling. This determination process is described in more detail below. The processing circuitry 106, as in the described implementation, may also be configured to, with appropriate analysis of relative changes in the electrodes' measured capacitance/capacitive coupling, calculate a touch position on the cover's surface as an XY coordinate 111. In some implementations, the processing circuitry 106 may also be configured to establish whether an object “hovers” over the sensing area of the sensor element 100, that is, the object is within a distance of the sensing area that the sensing area can reliably detect the hovering object, but the hovering object is not in contact with the sensing area of the sensing element 100. In some implementations, the processing circuitry 106 may also be configured to sense a position of the hovering object. For convenience, an object being directly in contact with the sensing area of the sensing element 100 or hovering above the sensing area of the sensor element 100 will herein both be referred to as a touch unless otherwise stated. It should be appreciated that the underlying mechanism for determining the presence and/or position of a touch is broadly similar in either case (where it may be that only the various thresholds for determining a touch, i.e., changes in capacitance, are different for the different scenarios).

In the example of FIG. 1, a front cover (also referred to as a lens or panel) 108 is positioned in front of the substrate 103 and a single touch 109 on the surface of the cover 108 is schematically represented. Note that the touch itself does not generally make direct galvanic connection to the sensor 103 or to the electrodes 102. Rather, the touch influences the electric fields 110 that the measurement circuitry 105 generates using the electrodes 102 (described in more detail below).

A further aspect of capacitive touch sensors/touch sensitive apparatus 1 relates to the way the measurement circuitry 105 uses the electrodes of the sensor element to make its measurements. There are two main techniques for measuring capacitance, which are described below. Capacitive touch sensors may generally be configured to operate exclusively using one or the other of the two techniques, or a combination of the two (e.g., in a time-division multiplexed manner).

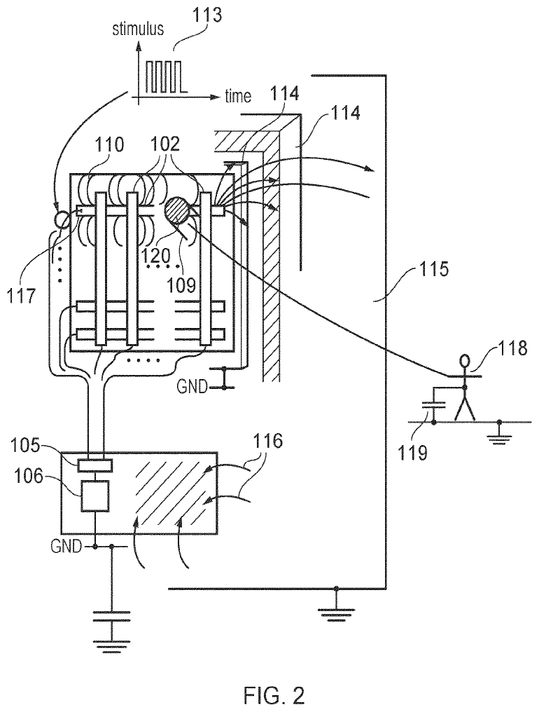

A first technique is based on measuring what is frequently referred to as “self-capacitance”. Reference is made to FIG. 2. In FIG. 2, an electrical stimulus (drive signal) 113 is applied to one or more of the electrodes 101, 102 which will cause an electric field 110 to form around it. This field 110 couples through the space around the electrode back to the measurement circuitry 105 via numerous conductive return paths that are part of the nearby circuitry of the sensor element 100 and the product housing (shown schematically by reference numerals 114), or physical elements from the nearby surroundings 115 etc., so completing a capacitive circuit 116. The overall sum of return paths is typically referred to as the “free space return path” in an attempt to simplify an otherwise hard-to-visualize electric field distribution. The important point to realise is that the capacitance measured by the measurement circuitry 105 is the “self-capacitance” of the sensor electrode (and connected tracks) that is being driven relative to free space (or Earth as it is sometimes called) i.e. the “self-capacitance” of the relevant sensor electrode. Touching or approaching the electrode with a conductive element, such as a human finger, causes some of the field to couple via the finger through the connected body 118, through free space and back to the measurement circuitry 105. This extra return path 119 can be relatively strong for large objects (such as the human body), and so can give a stronger coupling of the electrode's field back to the measurement circuitry 105; touching or approaching the electrode hence increases the self-capacitance of the electrode. The measurement circuitry 105 is configured to sense this increase in capacitance. The increase is strongly proportional to the area 120 of the applied touch 109 and is normally weakly proportional to the touching body's size (the latter typically offering quite a strong coupling and therefore not being the dominant term in the sum of series connected capacitances).

In the described implementation, the electrodes 101, 102 are arranged on an orthogonal grid, generally with a first set of electrodes on one side of a substantially insulating substrate 103 and the other set of electrodes on the opposite side of the substrate 103 and oriented at substantially 90° to the first set. In other implementations, the electrodes may be oriented at a different angle (e.g., 30°) relative to one another. In addition, it should also be appreciated that it is also possible to provide structures where the grid of electrodes is formed on a single side of the substrate 103 and small conductive bridges are used to allow the two orthogonal sets of electrodes to cross each other without short circuiting. However, these designs are more complex to manufacture and less suitable for transparent sensors. Regardless of the arrangement of the electrodes, broadly speaking, one set of electrodes is used to sense touch position in a first axis that we shall call “X” and the second set to sense the touch position in the second orthogonal axis that we shall call “Y”.

When the measurement circuitry 105 operates in accordance with the self-capacitance measuring mode, the measurement circuitry 105 can either measure each electrode in turn (sequential) with appropriate switching of a single control channel (i.e., via a multiplexer) or it can measure them all in parallel with an appropriate number of separate control channels. In the former sequential case, any neighbouring electrodes to a selected electrode are sometimes grounded by the measurement circuitry 105 to prevent them becoming touch sensitive when they are not being sensed (remembering that all nearby capacitive return paths will influence the measured value of the actively driven electrode). In the case of the parallel measurement scheme, in the absence of a touch the nature of the measurements received by all the electrodes is typically the same so that the instantaneous voltage on each electrode is approximately the same (e.g., this may be a measure of any noise). In this way, each electrode has minimal influence on its neighbours (the electrode-to-electrode capacitance is non-zero but its influence is only “felt” by the measurement circuitry 105 if there is a voltage difference between the electrodes).

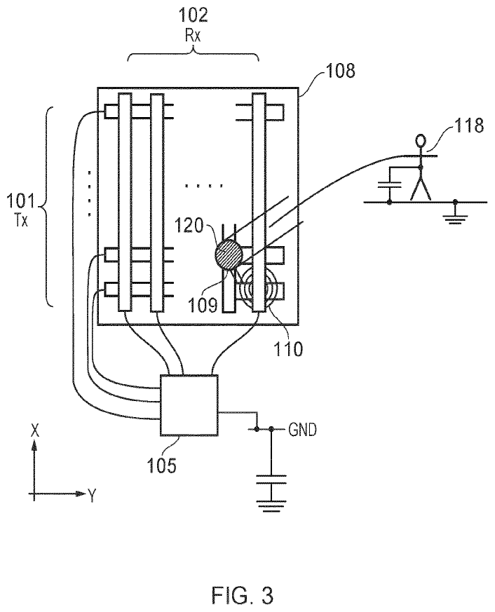

A second technique is based on measuring what is frequently referred to as “mutual-capacitance”. Reference is made to FIG. 3. In FIG. 3, a transmitter (driven/drive) electrode, shown as the X electrodes 101 in FIG. 3, is driven by a stimulus 113. In conventional systems, the stimulus is applied directly to the driven electrodes. The stimulus 113 is coupled to one or more receiver electrodes, by virtue of the driven electrodes proximity to an array of receiver electrodes, shown as the Y electrodes 102 in FIG. 3. (It should be appreciated that the Y electrodes 102 may instead be the transmitting electrodes and the X electrodes 101 may instead be the receiving electrodes in other implementations). The resulting electric field 110 is now directly coupled from the transmitter electrode to each of the nearby receiver electrodes; the “free space” return path discussed above plays a negligible part in the overall coupling back to the measurement circuitry 105 when the sensor element 100 is not being touched. The area local to and centred on the intersection of a transmitter and a receiver electrode is typically referred to as a “node” or “intersection point”. In the conventional case, where the drive signal is applied to a driven electrode, on application or approach of a conductive element such as a human finger, the electric field 110 is partly diverted to the touching object. An extra return path to the measurement circuitry 105 is now established via the body 118 and “free-space” in a similar manner to that described above. However, because this extra return path acts to couple the diverted field directly to the measurement circuitry 105, the amount of field coupled to the nearby receiver electrode 102 decreases relative to the situation where no body 118 is present. This is measured by the measurement circuitry 105 as a decrease in the “mutual-capacitance” between that particular transmitter electrode and receiver electrodes in the vicinity of the touch 109. The measurement circuitry 105 senses this change in capacitance of one or more nodes. For example, if a reduction in capacitive coupling to a given Y-electrode is observed while a given X-electrode is being driven, it may be determined there is a touch in the vicinity of where the given X-electrode and given Y-electrode cross, or intersect, within the sensing area of the sensor element 100. The magnitude of a capacitance change is nominally proportional to the area 120 of the touch (although the change in capacitance does tend to saturate as the touch area increases beyond a certain size to completely cover the nodes directly under the touch) and weakly proportional to the size of the touching body (for reasons as described above). The magnitude of the capacitance change also reduces as the distance between the touch sensor electrodes and the touching object increases.

As described above, the transmitter electrodes and receiver electrodes in the described implementation are arranged as an orthogonal grid, with the transmitter electrodes on one side of a substantially insulating substrate 103 and the receiver electrodes on the opposite side of the substrate 103. This is as schematically shown in FIG. 3. As in FIG. 2, the first set of transmitter electrodes 101 shown on one side of a substantially insulating substrate 103 and the second set of receiver electrodes 102 is arranged at nominally 90° to the transmitter electrodes on the other side of the substrate 103. In other implementations, the electrodes may be oriented at a different angle (e.g., 30°) relative to one another. In addition, other implementations may have structures where the grid is formed on a single side of the substrate and small insulating bridges, or external connections, are used to allow the transmitter and receiver electrodes to be connected in rows and columns without short circuiting.

Depending on the application at hand, the touch-sensitive apparatus 1 may be configured to operate using one or both of the abovementioned measurement techniques. Mutual capacitance measurement techniques offer the ability to resolve multiple touches at different locations on the touch-sensitive element, and while self-capacitance measurement techniques do not, as a matter of course, provide this functionality, self-capacitance measurement techniques generally output a much stronger signal thus increasing the sensitivity of the touch-sensitive element.

In some conventional touch-sensitive apparatuses, the stimulus 113 (or drive signal) for obtaining the mutual or self-capacitance measurements is provided to the electrode array via suitable circuitry that is physically connected or coupled to the touch-sensitive apparatus. For example, the measurement circuitry 105 may be provided with drive circuitry configured to generate one or more drive signals 113 (for example, taking the form of a time-varying current, such as a sinusoidal current). The drive signal 113 generated by the drive circuitry is then applied to a given drive electrode of the electrode array 101, 102. For example, the measurement circuitry 105 may couple to a first terminal 117 of an electrode of the electrode array and supply the drive signal 113 accordingly. A measurement of the capacitance (self-or mutual capacitance) can be obtained using the techniques discussed above.

Typically, to perform a full scan of the electrode array (that is, where the capacitance associated with each electrode or each intersection of the electrode array is measured), the drive signal is applied to each of the transmit electrodes (in the case of mutual capacitance measurement techniques) or each of the electrodes (in the case of self-capacitance measurement techniques) of the electrode array and corresponding measurements are made. This may include applying the drive signal sequentially to various electrodes of the electrode array and/or applying the drive signal (or multiple drive signals) to the various electrodes of the electrode array.

Importantly, it should be understood that in the aforementioned conventional touch-sensitive apparatuses, the drive signal 113 originates from the touch-sensitive apparatus (i.e., from circuitry provided in the touch-sensitive apparatus). That is to say, the touch sensitive apparatus itself generates the drive signal 113. The drive signal 113 is applied to the electrode array 101, 102 via conductive traces that are permanently or selectively coupled (e.g., through a multiplexer) to the respective electrodes of the electrode array. That is, there is physical pathway through which the drive signal 113 is applied to the electrode array, and that physical pathway is a part of the touch-sensitive apparatus. In these examples, when a user touches or interacts with the driven electrode, the capacitance (self or mutual) associated with the driven electrode experiences a change, as described above, and this change can be measured and interpreted by the touch-sensitive apparatus 1 as signifying a touch on the touch-sensitive apparatus.

However, in accordance with the present disclosure, the Inventor has identified an alternative way in which given electrodes of an electrode array may be driven. As will be described in more detail below, such an approach has advantages over conventional techniques, for example, by allowing differentiation between users.

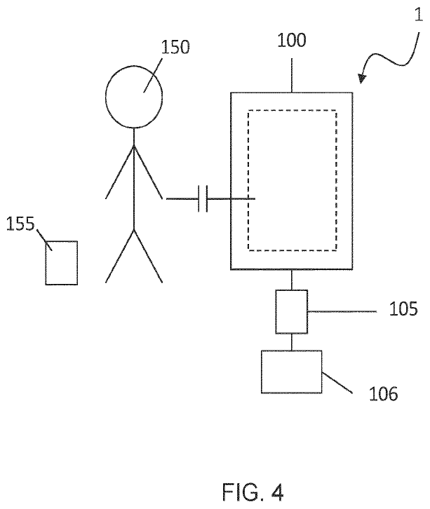

FIG. 4 is a schematic representation of a touch-sensitive system in accordance with the principles of the present disclosure. The touch-sensitive system comprises the touch-sensitive apparatus 1 of FIG. 1 (shown highly schematically in FIG. 4, with certain components not being shown to improve the clarity thereof), in addition to a first transmitter 155. That is to say, the touch-sensitive apparatus 1 and first transmitter 155 together form the touch-sensitive system.

The transmitter 155 (or sometimes referred to herein as transmitter apparatus) is configured to generate a drive signal, such as the drive signal 113 described above. The transmitter 155 comprises suitable drive circuitry (not shown) to generate the drive signal 113. The transmitter 155 generates and outputs the drive signal 113 (described in more detail below). As can be seen in FIG. 4, the transmitter 155 is physically separate or remote from the touch-sensitive apparatus 1. In particular, the transmitter 155 is not provided with a direct, physical connection to the electrode array 101, 102 of the touch-sensitive apparatus 1, and therefore is unable to output the generated drive signal 113 directly to electrodes of the electrode array 101, 102.

However, the transmitter 155 is configured to apply the drive signal to a first user 150. The transmitter 155 is configured such that the output of the transmitter 155 (i.e., the drive signal 113) electrically couples to the user 150, for example, via a conductive substrate that is coupled to the transmitter 155 and also contacts or touches the user 150. Accordingly, when the user 150 interacts with (touches) the sensing area of the touch-sensitive apparatus 1, i.e., by bringing their finger or a held stylus close to or in contact with the sensing area of the touch-sensitive apparatus 1, the drive signal 113 generated by the transmitter 155 and applied to the user 150 is indirectly coupled to the electrode array 101, 102. That is, the user 150 acts as a conduit for the drive signal 113 generated by the remote transmitter 155, such that the drive signal 113 is able to electrically (capacitively) couple to the electrode array 101, 102. This is shown schematically in FIG. 4 by the capacitor shown between the user 150 and the sensing area of the touch-sensitive apparatus 1. While there may be a physical pathway between the transmitter 155 and the electrode array 101, 102, this physical pathway is formed in part by the user 150, and thus is not a part of the touch-sensitive apparatus 1. The drive signal 113 is suitably set so as to have no risk (or a low risk) of injuring the user 150 when it is applied to the user 150 by the transmitter 155.

The measurement circuitry 105 of the touch-sensitive apparatus 1 is configured to operate largely in accordance with the self-capacitance measurement technique as described above (i.e., as described in relation to FIG. 2). In particular, the measurement circuitry 105 is configured to obtain measurements from each electrode of the electrode array 101, 102, whereby the measurements are indicative of the capacitive coupling of the user 150 to the electrode array 101, 102. In particular, depending on the location at which the user touches the touch-sensitive element, the drive signal 113 capacitively couples to one or more of the electrodes corresponding to the touch location. By determining which electrodes of the electrode array 101, 102 subsequently show a coupling to the drive signal 113, an X-Y position corresponding to the touch location can be determined. For example, by measuring the self-capacitance of each of the X-electrodes 101 and each of the Y-electrodes 102, for a given position on the surface of the touch sensitive element, one would expect a capacitive signal to be measured on at least one X-electrode 101 and at least one Y-electrode 102. Based on which X and Y electrodes register a signal, corresponding to the coupling of drive signal 113 to the electrode array 101, 102, a position of the touch on the touch-sensitive element can be determined. In the process of measuring all the electrodes of the electrode array 101, 102, typically, one of the electrodes will be coupled to the measurement circuitry 105 which the remaining electrodes will be coupled to ground or held at a fixed potential. In this way, a measurement of a single electrode can be obtained. This process may be repeated sequentially for all electrodes.

In some implementations, the measurement circuitry 105 may be configured to obtain measurements of the electrode array 101, 102 on a periodic basis. That is, the measurement circuitry 105 may sequentially or simultaneously perform measurements of each of the electrodes 101, 102.

It should be understood that in the absence of a drive signal 113 being applied to the electrode array 101, 102 of the touch-sensitive apparatus 1 (e.g., when the user 150 does not touch the sensing area of the sensing element 100), the measurements obtained by the measurement circuitry 105 may be essentially zero or consist of any noise that may couple to the electrode array 101, 102. Hence, these measurements are considered to be indicative of the absence of a touch on the electrode array 101, 102/sensing area. Conversely, when the user 150 brings their hand/stylus or the like towards the electrode array 101, 102/sensing area of the touch-sensitive apparatus 1, the drive signal 113 from the transmitter 155 couples to one or more of the electrodes 101, 102 as described above. The measurement circuitry 105 therefore obtains a measurement which is indicative of a capacitive coupling at the one or more electrodes of the electrode array. This measurement typically will vary from the equivalent measurement made for the given electrode(s) in the absence of a touch. In this regard, because no drive signal 113 is present in the absence of a touch, the capacitive signal of a given electrode 101, 102 will increase from the baseline measurement obtained in the absence of a touch.

The processing circuitry 106 receives the measurements from the measurement circuitry 105 and is configured to perform processing on the basis of the received measurements. For example, the processing circuitry 106 may determine the presence/absence of a touch and/or the location of a touch and/or whether the touch is a hover touch or a contact touch (as described above). In this regard, the processing circuitry 106 is configured to determine the difference between the corresponding measurement (for an electrode or electrodes) made in the absence of a touch to the corresponding measurement made in the presence of a touch, and from the difference determine the presence/absence of a touch, etc. discussed above. For example, when the difference exceeds a threshold, the processing circuitry 106 determines that a touch is present. Accordingly, the processing circuitry 106 may output, or cause the output of, a signal indicative of information concerning the touch (presence, location, hover/contact, etc.), which may be received and processed by a corresponding host controller or the like. It should be appreciated that the measurements in the absence of a touch may be obtained in advance, e.g., as part of a calibration process, or may be routinely obtained during use of the touch-sensitive apparatus 1 (noting that typically a touch is likely to be detected for a fraction of the operational time of the touch-sensitive apparatus 1).

In some implementations, the transmitter 155 operates largely independently of the touch-sensitive apparatus 1. That is to say, the transmitter 155 is not controlled by the controller (e.g., the measurement circuitry 105 or processing circuitry 106). Accordingly, the transmitter 155 may be provided with its own control circuitry (not shown), which may govern the generation and/or transmission of the drive signal 113. For instance, when operational, the transmitter 155 may output the drive signal continuously or on a periodic basis. However, it should be appreciated that in other implementations, the controller (e.g., the measurement circuitry 105 or processing circuitry 106) may communicate with the transmitter 155 (e.g., through a wired or wireless communication link) to control operation of the transmitter 155. In such implementations, transmission of the drive signal 113 and performance of the measurements by the measurement circuitry 105 may be coordinated (that is, the measurement circuitry 105 may be controlled to obtain measurements at or slightly after the time of transmission of the drive signal 113 from the transmitter 155). It should be understood that although there may be a wired or wireless communication link in these implementations, the transmitter 155 is still not provided with a (direct) coupling to the electrode array 101, 102 as described above, and thus the transmitter 155 is unable to apply the drive signal 113 directly to the electrode array 101, 102. Hence, in both scenarios above, the transmitter 155 is remote from (i.e., not directly coupled to) the electrode array 101, 102 of the touch-sensitive apparatus.

The arrangement shown in FIG. 4, with the remote transmitter 155, provides an alternative way of driving the electrode array 101, 102 as compared to more conventional means described above. In particular, instead of applying a drive signal 113 directly to the electrode array 101, 102, using more permanent circuitry within the touch-sensitive apparatus 1 (such as connecting wires and/or multiplexes), the transmitter 155 is provided remote from the touch-sensitive apparatus 1 and therefore a reduction in the number of components/circuitry in the touch-sensitive apparatus 1 itself can be reduced.

In addition, the abovementioned configuration of FIG. 4 is advantageous when there are multiple users interacting with the same touch-sensitive apparatus 1. Conventionally, when a drive signal 113 is applied directly to the electrode array 101, 102, the processing circuitry 106 is incapable of distinguishing whether a first user or a second user touches the touch-sensitive apparatus 1. That is to say, a first user or a second user interacts with the driven electrode of the electrode array 101, 102 of touch-sensitive apparatus 1 in substantially the same way.

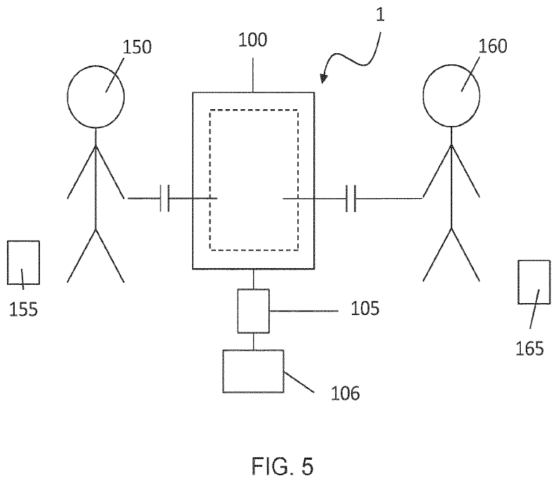

FIG. 5 is a schematic representation of a touch-sensitive system in accordance with the principles of the present disclosure according to an implementation whereby two users interact with the touch-sensitive apparatus 1. FIG. 5 will be understood from FIG. 4 and like components are identified with similar reference signs. For a detailed discussion on these components, the reader is referred to the above. Only the differences are described herein.

As seen in FIG. 5, the touch-sensitive system is provided with a second transmitter 165 which is suitably configured to apply a second drive signal to a second user 160. The second transmitter 165 is substantially the same as the first transmitter 155 described above; however, the second transmitter 165 is configured to apply a second drive signal to the second user 160 which is different from the first drive signal applied by the first transmitter 155 to the first user 150. In this regard, the first drive signal and the second drive signal may be time-varying drive signals and, accordingly, may vary by a predetermined frequency. The frequency of the first and second drive signal may be such that the first and second drive signals are orthogonal. Accordingly, the first transmitter 155 can be set to output a first drive signal having a first frequency, and the second transmitter 165 can be set to output a second drive signal having a second frequency different from the first frequency.

Accordingly, the processing circuitry 106 is configured to distinguish the measurements obtained by the measurement circuitry 105 to determine whether a given measurement is the result of the first drive signal being applied to the electrode array 101 102 or is the result of the second drive signal being applied to the electrode array 101, 102. In this regard, because the drive signals have different (orthogonal) frequencies, the processing circuitry 106 is able to distinguish which drive signal (first or second) was applied to the electrode array 101, 102. The processing circuitry 106 may be provided with information regarding the possible frequencies that are being used by the first and second transmitter 155, 165 so that it is capable of distinguishing the originating location of the first and second signals. For example, the touch-sensitive system 1 may be configured such that the first transmitter 155 uses frequency X (with the processing circuitry 106 programmed to associate frequency X with a first user) and the second transmitter 165 uses frequency Y (with the processing circuitry 106 programmed to associate frequency Y with a second user). Alternatively, the transmitter 155, 165 can communicate with the touch sensitive apparatus 1 to essentially communicate (e.g., via a suitable bus) with the processing circuitry 106 which frequency it is operating on (or conversely the touch sensitive apparatus 1 can tell the transmitter 155, 165 which frequency to operate on).

The processing circuitry 106 may be configured to perform an FFT (fast Fourier transform) on the received signal from the electrode array to establish the contributions resulting from the first and second frequencies, and hence the first and second users. Alternatively, the signals may be passed through one or more frequency filters (e.g., low or high pass filters, or any other suitable filter) to essentially identify contributions in the specific known frequency ranges (e.g., around frequency X or frequency Y described above) In addition, the processing circuitry 106 may also be able to distinguish between measurements occurring from the first and second drive signals when the first and second drive signals are applied simultaneously to the electrode array 101, 102 (that is, when the first user 150 and the second user 160 simultaneously touch the touch-sensitive apparatus 1). That is to say, the first and second user my simultaneously interact with the touch sensitive apparatus 1.

Once the processing circuitry 106 has distinguished whether the first drive signal or the second drive signal was applied (or the relative contributions thereof), the processing circuitry 106 is configured to determine the presence or absence of a touch (or any other parameter as listed above).

By way of example, as discussed above, the processing circuitry 106 is configured to obtain measurements corresponding to the X-electrodes 101 and the Y-electrodes 102 of the electrode array 101, 102. In the absence of any touch from either the first user 150 or the second user 160, the measurement corresponding to a given intersection is substantially zero or consists only of any noise (noting that the drive signal 113 is not applied to the electrode array 101, 102).

When the first user 150 touches the sensing surface, the first drive signal from the first transmitter 155 couples to one or more nearby electrodes 101, 102. The strength of the coupling of the first drive signal is proportional to the distance from the touch to the electrode—that is, if the first user touches at a position directly above a first X-electrode 101, the measurement of the capacitive coupling to this first X-electrode 101 is likely to be much stronger than a coupling to an adjacent X-electrode 101. In addition, the measurement of the given electrode additionally includes a component corresponding to the first drive signal.

Depending on the distance from the intersection/sensing surface, the strength of the first drive signal that couples to the intersection changes. For example, when the first user's finger or the like is further from the intersection, the strength of the coupling is less. Accordingly, based on the magnitude of the coupling, the processing circuitry 106 may be able to determine a relative position above the sensing surface (i.e., in the Z-direction, perpendicular to the sensing surface) of the first user's finger/touch. This may be achieved using one or more thresholds; for example, if the strength of the coupling (i.e., the magnitude of the coupling resulting from the first drive signal) is above a first threshold, this may signify that, at the intersection point, the first user 150 touches the sensing surface. If the strength of the coupling is above a second threshold but below a first threshold, this may signify that the finger or the like of the first user 150 hovers about the sensing surface at the location of the intersection point. If the strength of the coupling is below a second threshold, this may signify that no touch from the first user 150 is detected. It should be appreciated that there may be more or fewer thresholds, each corresponding to certain distances (in the Z-direction) of the detected user's finger or stylus. Alternatively, the processing circuity 106 may be configured just to determine whether there is or is not a touch from the first user 150 that is detected, for example, using a single threshold.

When the second user 160 touches the sensing surface, the second drive signal from the second transmitter 165 couples to one or more nearby electrodes 101, 102. The strength of the coupling is proportional to the distance from the touch to the electrode—that is, if the second user touches at a position directly above a first X-electrode 101, the measurement of the capacitive coupling to this first X-electrode 101 is likely to be much stronger than a coupling to an adjacent X-electrode 101. In addition, the measurement of the given electrode alternatively (or additionally) includes a component corresponding to the second drive signal. This may be in addition to the component of the first drive signal or separate from. In either case, the processing circuitry 106 may use the same or similar thresholds to determine similar information regarding the second user's touch. That is, if the strength of the coupling (i.e., the magnitude of the coupling resulting from the second drive signal) is above a first threshold, this may signify that, at a position corresponding to the given electrode, the second user 160 touches the sensing surface. If the strength of the coupling is above a second threshold but below a first threshold, this may signify that the finger or the like of the second user 160 hovers about the sensing surface at the location of the given electrode. If the strength of the coupling is below a second threshold, this may signify that no touch from the second user 160 is detected. It should be appreciated that there may be more or fewer thresholds, each corresponding to certain distances (in the Z-direction) of the detected user's finger or stylus. Alternatively, the processing circuity 106 may be configured just to determine whether there is or is not a touch from the second user 160 that is detected, for example, using a single threshold.

It should be appreciated that the processing circuitry 106 is able to determine the location of a touch from either of the first user and the second user based on measurements corresponding to the various electrodes of the electrode array 101, 102. As above, based on correlating the signals from the X-electrodes 101 and the Y-electrodes 102, an X, Y position on the sensing area can be determined for the touches of the first and second users.

In respect of the thresholds described above, these may be set in accordance with any suitable technique, which may depend on the application at hand. In some implementations, the thresholds may be set based on the measurement(s) obtained in the absence of a touch. For example, the threshold may be, e.g., an amount greater than the measurement obtained in the absence of a touch. That is, the thresholds may be set relative to the measurement(s) obtained in the absence of a touch. Alternatively, the thresholds may be an absolute value, e.g., a coupling of magnitude X.

In either case, the thresholds are set in advance, for example as part of a calibration process. Calibration may be performed e.g. at the manufacturing factory or upon initial use of the touch-sensitive system by a user. In either case, the calibration may involve a user, to which the drive signal is applied, making physical contact with the sensing area of the touch-sensitive apparatus 1. The direct physical contact should provide the greatest signal that the measurement circuity 105 or processing circuitry 106 should expect to receive, and therefore this value can be a representation of the maximum signal strength. Correspondingly, from this, the processing circuitry 106 can ascertain the various thresholds. The calibration process may also involve obtaining measurements from different distances (in the Z-direction) from the sensing surface.

Alternatively, while it has been described that the processing circuitry may use various thresholds to determine the presence and/or distance from the sensing surface of a touch, in other implementations, the processing circuitry 106 may be provided with various algorithms/equations or a look-up table to provide an indication of the presence and/or distance from the sensing surface of a touch. The various values for the look-up table of equations may be determined through a suitable calibration process.

Accordingly, the touch-sensitive system of FIG. 5, which includes a touch-sensitive apparatus 1 and two transmitters, a first transmitter 155 and a second transmitter 165, enables the identification and differentiation of touches originating from different users 150, 160. Broadly speaking, therefore, the touch-sensitive system as described above (or the controller thereof) is capable of determining, as a property of the detected touch or object, at least one of: the presence of a touch or object at the sensing surface, a position on the sensing surface of the touch or object, a distance relative to the sensing surface of the touch or object (i.e., in the Z-direction), and an origin of the touch or object (e.g., whether the touch originates from the first user 150 or the second user 160). In this way, two different users 150, 160 are able to interact with the same touch-sensitive apparatus 1, and the processing circuitry 106 is capable of identifying and distinguishing different inputs corresponding to the different users. Depending on the implementation at hand, the processing circuitry 106 may output, or cause the output of, different signals corresponding to the different inputs received from the different users. These signals may be received by a host controller which may cause process the signals accordingly.

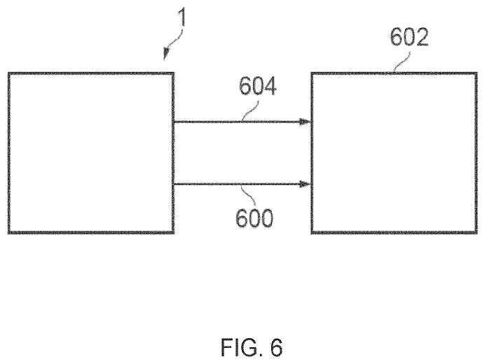

FIG. 6 is a highly schematic diagram showing the touch sensitive apparatus 1 coupled to an associated apparatus 602. The associated apparatus 602 generally comprises a computer processor which is capable of running a software application, and may also comprise a display element, such as an LCD screen or the like. In some implementations, the touch sensitive apparatus 1 is integrally formed with the associated apparatus 602, whereas in other implementations the touch sensitive apparatus 1 is able to be coupled to the associated apparatus 602 e.g., via electrical wiring. As described above, in some instances the substrate 103 and cover 108 of the touch sensitive apparatus 1 are transparent and a display element is placed behind the substrate 103 and cover 108, such as in a smartphone.

The touch sensitive apparatus 1 functions as an input mechanism for the associated apparatus 602. The processing circuitry 106 outputs a signal 600 indicating the presence, location and/or distance above the sensing surface of a touch corresponding to either the first user 150 or second user 160 to the processing circuitry (host controller) of the associated apparatus (not shown). In some applications, signal 600 may simply indicate whether or not a genuine touch has been detected on the touch-sensitive element, whereas in other instances, the signal 600 may indicate one or more positions of the touch or touches on the sensing area, for example as X, Y coordinates (corresponding to the given electrodes), and/or the distance of the touch from the sensing area (i.e., a Z-position). The processing circuitry of the associated apparatus 602 may process the signal 600 in accordance with the application being run on the associated apparatus, e.g., by causing the associated apparatus to perform an action or change the image(s) that is displayed on the display unit. Additionally, the host controller may perform different functions or control based on whether the signal is indicative of an input from the first user 150 or second user 160.

It should be appreciated that while the touch-sensitive system of FIG. 5 shows two users 150, 160 each having a transmitter 155, 165, it should be understood that the principles of the present disclosure can be extended to any number of users each having their own corresponding transmitter configured to output a unique drive signal (i.e., unique between the plurality of transmitters). For example, four users may each be provided with a transmitter (i.e., four transmitters in total) with each transmitter having a different drive signal. In such a case, the controller (e.g., processing circuitry 106) is configured to distinguish touches originating from the four respective users.

The arrangement described in FIG. 5 utilises the first drive signal from transmitter 155 and/or the second drive signal from transmitter 165 as the only drive signals for the touch-sensitive apparatus 1. That is to say, aside from any noise, the only drive signal applied to the touch-sensitive apparatus 1 and the electrode array 101, 102 thereof, originate from the remote transmitters 155, 165. However, this need not be the case.

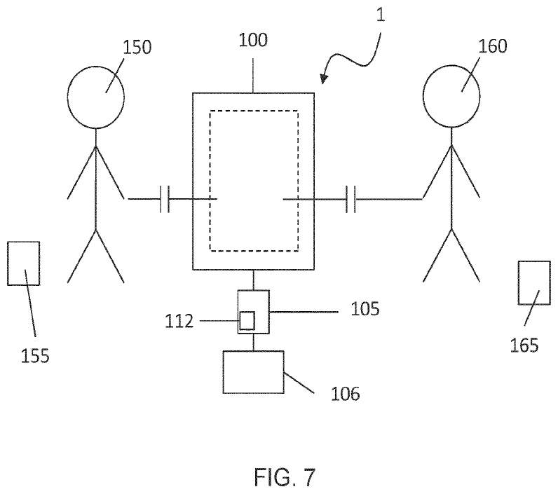

FIG. 7 is a schematic representation of a touch-sensitive system in accordance with the principles of the present disclosure according to a second implementation whereby two users interact with the touch-sensitive apparatus 1. FIG. 7 will be understood from FIG. 5 and like components are identified with similar reference signs. For a detailed discussion on these components, the reader is referred to the above. Only the differences are described herein.

In the touch-sensitive system of FIG. 7, the touch-sensitive apparatus 1 further includes drive circuitry 112 (shown in FIG. 7 as forming a part of the measurement circuitry 105, but in other implementations this may be integrated with the processing circuitry 106 or separate from both the measurement circuitry 105 and processing circuitry 106). The drive circuitry 112 is configured to apply a third drive signal directly to the electrode array 101, 102. That is to say, circuitry (not shown) couples the drive circuitry 112 to one or more electrodes of the electrode array (for example, each of the X-electrodes 101). The third drive signal generated by the drive circuitry 112 is substantially similar to the first and second drive signals, but differs therefrom (e.g., the third drive signal is a time-varying signal but has a different frequency to the first and second drive signals).

In the configuration of FIG. 7, the operation of the measurement circuitry 105 and drive circuitry 112 may be broadly conventional. That is, for example, the drive circuitry 112 may sequentially apply the third drive signal to the X-drive electrodes 101 while the measurement circuitry 105 obtains measurements indicative of the self-capacitance of the drive electrodes 101, and/or of the mutual capacitance with respect to the Y-receive electrodes 102 (as described above with reference to FIG. 3). Broadly speaking, driving the electrode array 101, 102 as above using the third drive signal can provide information on the presence/absence of a touch, the location (i.e., X, Y position) of a touch and, in some implementations, the position of a touch above the sensing surface (i.e., a Z position). However, driving the electrode array 101, 102 solely using the third drive signal typically does not provide information on the origin of the touch (i.e., whether the touch originated from a first user 150 or second user 160).

Accordingly, by providing the first and second transmitters 155, 165 and providing the first and second drive signals to the first and second users respectively, the processing circuitry 106 is capable of determining whether there is a component of a given measurement obtained by the measurement circuitry 105 which is due to the coupling of the first drive signal or the second drive signal. That is to say, the processing circuitry 106 determines whether measurements obtained by the measurement circuitry 105 resulting from application of a third drive signal to the electrode array 101, 102 additionally include a component that corresponding to the first or second drive signals (and hence the first or second user 150, 160).

By way of example, we refer to an example in which the measurement circuitry 105/processing circuitry 106 use the mutual capacitance measurement technique in respect of the third drive signal, and in which the measurement circuitry 105/processing circuitry 106 utilises the self-capacitance measurement technique in respect of the first and second drive signals.

On the one hand, for a given intersection of the electrode array (i.e., an intersection of an X-electrode 101 and a Y-electrode 102), the third drive signal is applied to a drive electrode (e.g., an X-electrode 101) while the measurement circuitry 105 is coupled to the corresponding receive electrode (e.g., a Y-electrode 102). In the absence of a touch, the measurement circuitry 105 outputs a measurement indicative of the capacitive coupling between the drive and receive electrodes corresponding to the application of the third drive signal. When a user touches the sensing surface at a location corresponding to the intersection, as discussed above, the user capacitively influences the capacitive coupling at the intersection (typically decreasing the measured capacitance resulting from the third signal). In instances where the user 150, 160 is also in contact with a transmitter 155, 165, while the capacitive coupling between the drive electrode and the receive electrode resulting from the third drive signal may decrease, due to the presence of the first or second drive signal, the measurement indicative of the capacitance at the intersection received by the measurement circuitry 105 includes a contribution resulting from the first or second drive signal. That is, any given measurement from the electrode array 101, 102 includes a contribution from the third drive signal (which is relatively decreased from the situation where no touch is detected) and optionally a contribution from the first and/or second drive (which is relatively increased, or more accurately just present, from the situation where no touch is detected).

Accordingly, based on the presence of a contribution to the measurement from the first or second drive signal, the processing circuitry 106 is able to determine whether or not a detected touch at the given intersection was applied by the first user 150 or the second user 160. Hence, broadly, it can be seen that the processing circuitry 106 is capable of determining whether a touch was applied by a first or second user based on the presence of a drive signal different to the drive signal applied directly to the electrode array 101, 102.

In some implementations, the controller (e.g., the processing circuitry 106) is configured to determine the position of the touch or object relative to the sensing surface on the basis of the received signal (measurement) based on the third drive signal applied by the drive circuitry 112. That is, for example, the position of the touch or object can be ascertained by comparing the magnitude of the third drive signal (or its coupling to the receive electrode) in the absence of a touch, with the magnitude of the third drive signal (or its coupling to the receive electrode) in the presence of a touch.

In some implementations, the controller (e.g., the processing circuitry 106) is configured to determine the location of the touch above the sensing surface on the basis of the received signal (measurement) based on the third drive signal applied by the drive circuitry 112. That is, for example, the position of the touch or object above the sensing surface can be ascertained by comparing the magnitude of the third drive signal (or its coupling to the receive electrode) in the absence of a touch, with the magnitude of the third drive signal (or its coupling to the receive electrode) in the presence of a touch. As noted above, in this case, when the user's finger or object is further from the touch sensitive surface, the reduction of the mutual capacitance between the respective electrodes of the intersection is less. In other implementations, the controller (e.g., the processing circuitry 106) is configured to determine the location of the touch above the sensing surface on the basis of the received signal (measurement) based on the first or second drive signal applied by the transmitters 155, 165. That is, for example, the position of the touch or object above the sensing surface can be ascertained by measuring the magnitude of the first or second drive signal (or its coupling to the receive electrode). As noted above, in this case, the closer the user's finger or object is to the touch sensitive surface, the stronger the coupling to the receive electrode.

Accordingly, the touch-sensitive system of FIG. 7 is configured to use the third drive signal as a mechanism to determine the presence and/or location of a touch on the touch-sensitive apparatus, but to additionally use the first or second drive signal as an indicator as to whether the touch originated from the first user 150 or the second user 160. Hence, for any given touch, the controller of the touch-sensitive apparatus 1 may use a plurality of drive signals to ascertain certain properties of or associated with the touch.

As described above, the controller may use either of the third drive signal or the first or second drive signal to ascertain information regarding the position above the sensing surface (or more accurately, the distance from the sensing surface). However, particularly when the touch-sensitive system is configured to use the mutual capacitance measurement technique in respect of the third drive signal—that is to say the position of a touch is determined using the third drive signal applied to the electrode array—multiple touches by one or more of the users can be determined.

In this regard, if a two-by-two grid of electrodes is considered (that is two X electrodes and two Y electrodes) it is clear that there are four intersections. If we label each electrode as X1, X2 and Y1, Y2, each intersection point can be considered as e.g., X1Y1 (this is the point where electrode X1 and electrode Y1 intersect), X1Y2, etc. In the context of a self-capacitance measurement technique, when a single user touches at two different locations on the electrode array, e.g., X1Y1 and X2Y2, a signal is detected on each electrode—that is, there is a signal on electrode X1, a signal on electrode X2, etc. In this case, it can be seen that it is impossible to determine whether the user touches at locations X1Y1, X2Y2 or at the locations X2Y1, X1Y2. In the self-capacitance measurement technique, it is therefore difficult to determine the locations of multiple touches from a single user. This is clearly the same problem that arises in the context of the system described in FIGS. 4 and 5 above. Conversely, this problem is overcome by using the mutual capacitance measurement technique and the third drive signal in the example of FIG. 7. The positions of multiple touches (from a single user) can be correctly identified using the mutual capacitance technique. Moreover, using the first and second drive signals in addition to the mutual capacitance technique can help discriminate where these one or multiple touches originated from. In broad summary, using a conventionally driven electrode array drive by a third signal and driving electrodes using first and second drive signals from the remote transmitters 155, 165 allows for a touch-sensitive system in which multiple touches from a single user can be discriminated between and one or more touches from different users can additionally be discriminated between.

Although the above has described the touch-sensitive systems of FIGS. 4, 5, and 7 as having a single touch sensitive apparatus 1, it should be appreciated that the principles of the present disclosure can be applied to systems in which there are multiple touch-sensitive apparatuses. For example, in respect of FIGS. 4 and 5 in particular, a single transmitter can be used to provide a drive signal to any one of multiple touch-sensitive apparatuses. This may reduce energy consumption and/or the number of components within the overall system.

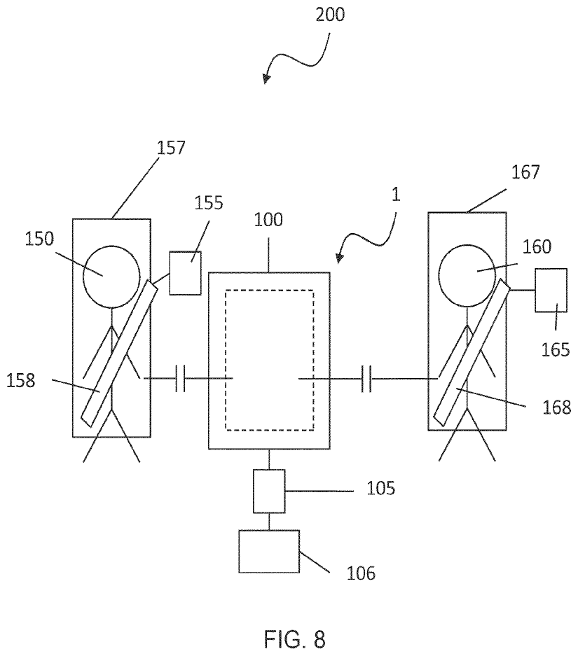

FIG. 8 represents an example scenario where the touch-sensitive systems of FIGS. 5 and 7 may be utilised. FIG. 8 highly schematically shows the layout of a vehicle 200, such as a car, comprising a first seat 157 and a second seat 167. FIG. 8 will be broadly understood from FIG. 5, and like components are referenced with the same reference numerals.

In the example scenario shown in FIG. 8, the touch-sensitive apparatus 1 forms a suitable user interface (UI) in the vehicle 200. For example, the touch-sensitive apparatus 1 may be located on the dashboard of the vehicle 200. Additionally, the vehicle 200 comprises two seats 157, 167 which may form a driver seat (e.g., seat 157) and a passenger seat (e.g., seat 167). The seats comprise safety belts 158 and 168 respectively.

As seen in FIG. 8, the first and second transmitters 155, 165 are coupled to the safety belts 158, 168. Typically, the safety belts 158, 168 will make contact the users 150, 160 when the users 150, 160 are seated in the seats 157, 167 and the safety belts 158, 168 are properly utilised. In this example, the safety belts 158, 168 are formed of or comprise an electrically conductive element (for example, the safety belts 158, 168 may be formed of a fabric, and may comprise one or more conductive fibres, e.g., such as a metal, woven into or otherwise forming the fabric). The first and second transmitters 155, 165 are arranged to electrically couple to the electrically conductive element of the safety belts 158, 168 such that the respective drive signals 113 generated by the first and second transmitters 155, 165 are able to be transmitted to the safety belts 158, 168. In particular, the first transmitter 155 is electrically coupled to the safety belt 158 of the first seat 157 such that the first drive signal is able to be transmitted to the safety belt 158 of the first seat 157, and the second transmitter 165 is electrically coupled to the safety belt 168 of the second seat 167 such that the second drive signal is able to be transmitted to the safety belt 168 of the second seat 167. Accordingly, because the safety belts 158, 168 respectively contact the users 150, 160 seated in the seats 157, 167, the respective drive signals that are transmitted to the safety belts 158, 168 can correspondingly be transmitted to the respective users 150, 160. In other words, the first drive signal generated by the first transmitter 155 can be transmitted to the first user 150 in the first seat 158 via the safety belt 157, while the second drive signal generated by the second transmitter 165 can be transmitted to the second user 160 in the second seat 168 via the safety belt 167.

Accordingly, the touch-sensitive apparatus 1 of FIG. 8 therefore functions in a similar manner to the touch-sensitive apparatus 1 of FIG. 5 or 7 as described above. That is, when a touch (or object) is detected by the touch-sensitive apparatus 1, the touch-sensitive apparatus 1 is capable of determining whether the touch originates from the first user 150 or the second user 160 by determining whether the frequency components of measurements obtained by the measurement circuitry 105 correspond to the frequency of the first drive signal or the frequency of the second drive signal. The processing circuitry 106 may then output a signal (e.g., signal 600) indicative of properties of the sensed touch(es), such as the position, the location/distance above the sensing surface, and whether the touch was caused by (originated from) the first or second user. These signals are output to a corresponding host controller of the vehicle 200 (corresponding to apparatus 602 in FIG. 6), where the host controller of the vehicle 200 performs the relevant functions.

By way of example only, the touch-sensitive apparatus 1 (or the sensing surface thereof) may include a region which corresponds to a particular function. For example, the region may correspond to the function of displaying the current temperature (e.g., as set by a climate control system) inside the vehicle 200. When a user touches the corresponding region on the sensing surface, a display (which may be part of or separate from the touch-sensitive apparatus) is controlled to display the current temperature. In some vehicles 200, there is the functionality to set local temperatures in different locations within the vehicle 200—for example, the temperature of the environment around seat 157 can be set to be different to the temperature of the environment around seat 167. In the present example, depending on which user (i.e., user 150 or 160) touches the region of the sensing surface, the touch-sensitive apparatus 1 can cause the display to display the local temperature around the current user's seat 157, 167. Such an arrangement may generally provide benefits such as more efficient use of the space of the user interface (e.g., in the above example, only a single region is required).

Additionally, it should be understood that certain functionality may be blocked depending on where the touch originates. For example, in some implementations, the driver of the vehicle 200 may be prevented from performing certain functions (e.g., inputting of a GPS coordinates or use of other driver navigation systems) when the vehicle 200 is in motion. Conversely, touch inputs received from the passenger may not be blocked. In this case, the decision to block or not block certain inputs may be performed by the host controller, depending on the origin of the detected touch. That is, the touch-sensitive apparatus 1 may still detect the presence of a touch from the driver, but the host controller may decide to take no action on the basis that this touch originates from the driver and the vehicle 200 is in motion.

In other examples, the touch-sensitive system may be used for playing games—e.g., when the vehicle 200 is stationary and/or if the touch-sensitive apparatus is provided so as to be accessible to the rear passengers. For example, a game such as noughts and crosses may be played by attributing the output of one transmitter 155 with e.g., noughts, and the output of the other transmitter 165 with, e.g., crosses. Based on which user touches, e.g., a display which is overlain by the touch-sensitive element 100, the processing circuitry 106 can be configured to display a nought or a cross at the detected touch location depending on the user who is determined to touch that location. Other potential uses of the touch-sensitive system and/or other functions the touch-sensitive system may be able to perform or cause to be performed are contemplated by this disclosure.

While the above has described the transmitters 155, 165 as being conductively coupled to a safety belt 158, 168 of the seats 157, 158, it should be understood that this is just an example implementation. In other implementations, the transmitters 155, 165 may be coupled to the seats 157, 167 in other ways; for example, the seat 157, 167 itself may be formed of a conductive material or have a region that is formed of a conductive material to which the transmitter 155, 165 is coupled.

It should be appreciated that the above example of FIG. 8 shows the touch-sensitive system located in a vehicle 200. However, the touch-sensitive system is not limited to being implemented in vehicles 200. In other implementations, the touch-sensitive system may be implemented in other scenarios with seating, such as a classroom or lecture theatre, cinema, restaurants, etc. Moreover, as noted above, the touch-sensitive system is not limited to uses in which seating is provided; for example, the transmitters 155, 165 may be designed so as to be portable and couple to a user (for example, on a belt buckle or as a wearable device). In other situations, the transmitters may be coupled to floor tiles or the like (for example, surrounding an interactive blackboard/whiteboard). It should be understood that the transmitters 155, 165 may be used in a wide range of scenarios, and depending on the application at hand, the transmitters 155, 165 may be suitable adapted.

In the context of transmitters 155, 165 that are fixedly coupled to a location (for example, a seat), it should be appreciated that the touch-sensitive apparatus 1 is not necessarily configured to identify the user per se, but the seat/transmitter 155, 165. In other words, if user 150 and user 160 swapped positions in the arrangement of FIG. 8, the touch-sensitive apparatus 1 would not be able to distinguish from the situation as shown in FIG. 8—in other words, the touch-sensitive apparatus 1 would consider touches originating from the user 150 sitting in seat 167 to originate from the user 160 (now sitting in seat 157). Strictly speaking, therefore, the origin of the touch in these scenarios is the seat 157, 167 (or the object to which the transmitter is fixedly located). However, in situations where the transmitter 155, 165 is portable and/or attached to the user, positional changes of the user with respect to the touch-sensitive apparatus 1 do not influence the ability of the touch-sensitive apparatus 1 to distinguish which user applied the touch. In these implementations, the origin of the touch is the user.

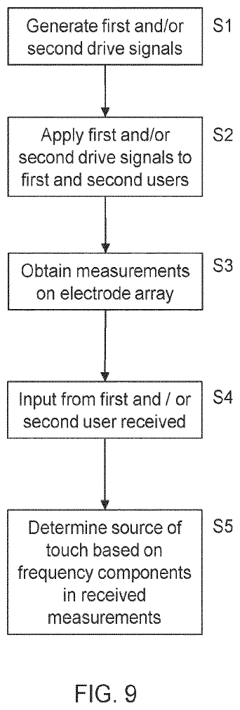

FIG. 9 is a flow diagram showing a method for operating the touch-sensitive systems according to aspects of the present disclosure, such as the touch-sensitive systems shown in FIGS. 4, 5, 7 and 8.

The method begins at step S1 where the first transmitter 155 and/or second transmitter 165 are controlled to generate the first drive signal and/or the second drive signal respectively. As described above, the first and/or second transmitters 155, 165 may be controlled independently of the touch-sensitive apparatus 1 and may be provided with their own control circuitry. For example, the first and second transmitters 155, 165 may be provided with a switch or the like which, when set to an “on” position, provides power to the drive circuitry to start generating the drive signal. As mentioned above, however, other mechanisms for controlling the transmitters 155, 165 are also contemplated.

At step S2, the first and/or second drive signals generated at step S1 are applied to the first and/or second users 150, 160 accordingly. As discussed above, the transmitters 155, 165 may be configured to apply the drive signals directly to a user or to a conductive element arranged between the user and the transmitter (such as the safety belt 158, 168 of FIG. 8).

The method proceeds to step S3. At step S3, measurements of the electrode array 101, 102 are obtained by the measurement circuitry 105. As described above, these measurements may be obtained periodically, or according to any other schedule. Additionally, the measurements may be indicative of the self-capacitance of individual electrodes and/or of the mutual capacitance between pairs of electrodes, as described above.

It should be appreciated that step S3 is shown as proceeding step S2. As described above, in some implementations, a controller (such as the controller including the processing circuitry 106) is configured to coordinate the obtaining of measurements by the measurement circuitry 105 and the generation of the first and/or second drive signals by the transmitters 155, 165. However, in situations where this is not the case, e.g., when the transmitters 155, 165 are operated independently of the touch-sensitive apparatus 1, then step S3 may be performed before, during or after steps S1 and S2. That is to say, when the touch-sensitive apparatus 1 is active (e.g., it is switched on, such as when the vehicle 200 is switched on), the measurement circuitry 105 may repeatedly perform measurements, even in the absence of a user touching the sensing area and/or generation of the first and/or second drive signals. The obtained measurements obtained by the measurement circuitry 105 are passed to the processing circuitry 106 for processing.

As described above, the processing circuitry 106 is configured to process the obtained measurements from the measurement circuitry 105. When no touch is detected, the processing circuitry 106 is configured to disregard the measurement results or, in some implementations, it may use these measurement results to update a value to be used as the reference or baseline value for comparison with subsequent measurements. When a touch is detected, the method proceeds to step S4 which indicates an input is received from the user (or users). As described above, once the drive signal is applied to the user 150, 160, when the user 150, 160 touches the sensing area of the touch-sensitive element 100, the respective drive signal is able to couple to the electrode array 101, 102. The drive signal as it couples to the electrode array 101, 102 influences the capacitive coupling associated with the electrodes 101, 102 as described above, and hence influences the measurements obtained by the measurement circuitry 105. This is subsequently detected by the processing circuitry 106 as described above.

It should be appreciated that the user may interact with the touch-sensitive apparatus 1 at any time after the first and/or second drive signals are generated and applied to the user(s), i.e., after steps S2 and S3. For example, although the first and/or second drive signals may be applied to the user at a first time, the user may not decide to touch (or otherwise interact) with the touch-sensitive apparatus 1 straight away. Equally, there may be instances where the user may not interact with the touch-sensitive apparatus 1 at all, and thus after step S3, the method may terminate by stopping generation of the first and/or second drive signals in response to a signal/input—for example, when the user switches off the vehicle 200.

Assuming a user input is received at step S4, the method proceeds to step S5. At step S5, the measurements of the electrode array 101, 102 obtained by the measurement circuitry 105 which are deemed to correspond to a touch are subsequently analysed to determine whether the measurement(s) have any component corresponding to the first or second drive signal. Subsequently, the processing circuitry 106 is capable of determining whether the measurement (and hence touch) originated from the first user (or a first object to which the first transmitter 155 is fixedly coupled) or from the second user (or a second object to which the second transmitter 165 is fixedly coupled). The processing circuitry 106 may then output a corresponding signal, such as signal 600, as is described above.

Although it has been described above that, where present, the first and second drive signals vary from one another in respect of their frequency, in other implementations, the first and second drive signals may alternatively vary from one another in respect of the phase of the signals. That is, the phase of the of the first drive signal and second drive signal may be different. In these implementations, the processing circuitry 106 is provided with an indication of the respective phases of the first and second drive signals, such that the processing circuitry 106 is capable of identifying and distinguishing between user touches originating from different users.

Thus there has been described a touch-sensitive system for sensing one or more touches or objects at a sensing surface. The touch-sensitive system includes an electrode array comprising at least one electrode, the electrode array defining the sensing surface; receiver circuitry configured to couple to the electrode array and receive signals from the electrode array; a controller configured to receive signals from the receiver circuitry and determine a property of a touch or object sensed at the sensing surface; and first drive circuitry configured to generate a first drive signal to be applied to the electrode array. The first drive circuitry is remote from the electrode array and arranged to apply the first drive signal to a user of the touch-sensitive system such that when a user of the touch-sensitive system touches or approaches directly, or via a held object, the sensing surface, the first drive signal is subsequently coupled to the electrode array. The receiver circuitry is configured to receive a signal from the electrode array corresponding to the first drive signal applied to the sensing surface via the user. Also described is a method of operating a touch-sensitive system for sensing one or more touches or objects at a sensing surface.

Further particular and preferred aspects of the present invention are set out in the accompanying independent and dependent claims. It will be appreciated that features of the dependent claims may be combined with features of the independent claims in combinations other than those explicitly set out in the claims.

1. A touch-sensitive system for sensing one or more touches or objects at a sensing surface, the touch-sensitive system comprising:
an electrode array comprising at least one electrode, the electrode array defining the sensing surface;
receiver circuitry configured to couple to the electrode array and receive signals from the electrode array;
a controller configured to receive signals from the receiver circuitry and determine a property of a touch or object sensed at the sensing surface; and
first drive circuitry configured to generate a first drive signal to be applied to the electrode array,
wherein the first drive circuitry is remote from the electrode array and arranged to apply the first drive signal to a user of the touch-sensitive system such that when a user of the touch-sensitive system touches or approaches, directly or via a held object, the sensing surface, the first drive signal is subsequently coupled to the electrode array, and
wherein the receiver circuitry is configured to receive a signal from the electrode array corresponding to the first drive signal applied to the sensing surface via the user.

2. The touch-sensitive system of claim 1, wherein the controller is configured to determine a property of the touch or object sensed at the sensing surface on the basis of the received signal from the electrode array corresponding to the first drive signal applied to the sensing surface via the user.

3. The touch-sensitive system of claim 1, wherein the controller is configured to determine, as a property of the touch or object sensed at the sensing surface, at least one of: the presence of a touch or object; a position on the sensing surface of the touch or object; a distance relative to the sensing surface of the touch or object; and an origin of the touch or object.

4. The touch-sensitive system of claim 1, wherein the controller, on the basis of the received signal from the electrode array corresponding to the first drive signal applied to the sensing surface via the user, is configured to determine a distance of the touch or object from the sensing surface as the property of the touch or object sensed at the sensing surface.

5. The touch-sensitive system of claim 4, wherein the distance of the touch or object from the sensing surface is determined based on the strength of the received signal from the electrode array corresponding to the first drive signal applied to the sensing surface via the user.

6. The touch-sensitive system of claim 4, wherein the touch-sensitive system further comprises third driving circuitry, the third driving circuitry configured to couple to the electrode array and apply a third driving signal directly to the electrode array, wherein the receiving circuitry is further configured to receive a signal from the electrode array based on the third drive signal, and the controller is configured to determine the position of the touch or object relative to the sensing surface on the basis of the received signal based on the third drive signal.

7. The touch-sensitive system of claim 1, wherein the controller, on the basis of the received signal from the electrode array corresponding to the first drive signal applied to the sensing surface via the user, is configured to determine the position of the touch or object relative to the sensing surface as the property of the touch or object sensed at the sensing surface.

8. The touch-sensitive system of claim 1, wherein the system further comprises second drive circuitry configured to generate a second drive signal to be applied to the electrode array, wherein the second drive circuitry is remote from the electrode array and arranged to apply the second drive signal to a second user of the touch-sensitive system such that when the second user of the touch-sensitive system touches or approaches directly, or via a held object, the sensing surface, the second drive signal is subsequently coupled to the electrode array.

9. The touch-sensitive system of claim 8, wherein the first drive signal and second drive signal are different from one another.

10. The touch-sensitive system of claim 9, wherein the first drive signal and second drive signal are sinusoidal signals each having a different frequency.

11. The touch-sensitive system of claim 8, wherein the controller is configured to determine whether a received signal from the receiver circuitry is based on the first drive signal or the second drive signal, and to determine an origin of a corresponding touch or object based on whether the received signal from the receiver circuitry is based on the first drive signal or the second drive signal.

12. The touch-sensitive system of claim 1, wherein the touch-sensitive system comprises:
a touch-sensitive apparatus comprising the electrode array, the receiver circuitry, and the controller; and
a first transmitter apparatus comprising the first drive circuitry,
wherein the touch-sensitive apparatus and the first transmitter apparatus are physically separate from one another.

13. The touch-sensitive system of claim 1, wherein the touch-sensitive system further comprises:
a second transmitter apparatus comprising the second drive circuitry,
wherein the touch-sensitive apparatus, the first transmitter apparatus and the second transmitter apparatus are all physically separate from one another.

14. The touch-sensitive system of claim 1, wherein the first drive circuitry and/or the second drive circuitry are configured to be operated independently of the controller.

15. A vehicle comprising the touch-sensitive system of claim 12, wherein the first transmitter apparatus is mounted to an electrically conductive component of a seat, wherein the electrically conductive component is arranged to contact a user when the user is sitting in the seat.

16. A method of operating a touch-sensitive system for sensing one or more touches or objects at a sensing surface, the touch-sensitive system comprising an electrode array comprising at least one electrode, the electrode array defining the sensing surface; receiver circuitry configured to couple to the electrode array and receive signals from the electrode array; a controller configured to receive signals from the receiver circuitry and determine a property of a touch or object sensed at the sensing surface; and first drive circuitry configured to generate a first drive signal to be applied to the electrode array, wherein the first drive circuitry is remote from the electrode array, the method comprising:
applying a first drive signal to a user of the touch-sensitive system,
coupling the first drive signal to the electrode array when a user of the touch-sensitive system touches or approaches, directly or via a held object, the sensing surface, and
receiving, at the receive circuitry, a signal from the electrode array corresponding to the first drive signal applied to the sensing surface via the user.

17. A vehicle comprising the touch-sensitive system of claim 13, wherein the first transmitter apparatus and/or second transmitter apparatus are each mounted to an electrically conductive component of a seat, wherein the electrically conductive component is arranged to contact a user when the user is sitting in the seat.
